(19) United States
(12) Patent Application Publication
(10) Pub. No.: US 2006/0149693 A1
(43) Pub. Date: Jul. 6, 2006

(54) Enhanced classification using training data refinement and classifier updating

(76) Inventors: Isao Otsuka, Nagaokakyo-city (JP); Regunathan Radhakrishnan, Attleboro, MA (US); Ajay Divakaran, Burlington, MA (US)

Correspondence Address: Mitsubishi Electric Research Laboratories, Inc.;Patent Department, 201 Broadway, Cambridge, MA, 02139, US

(21) Appl. No.: 11/028,970

(22) Filed: Jan. 4, 2005

(51) Int. Cl. G06F 15/18

(52) U.S. Cl. 706/20

(57) ABSTRACT

A method refines labeled training data audio classification of multimedia content. A first set of audio classifiers is trained using labeled audio frames of a training data set having labels corresponding to a set of audio features. Each audio frame of the labeled training data set is classified using the first set of audio classifiers to produce a refined training data set. A second set of audio classifiers is obtained using audio frames of the refined training data set, and highlights are extracted from unlabeled audio frames using the second set of audio classifiers.

### FIELD OF THE INVENTION

This invention relates generally to processing videos, and more particularly to detecting highlights in videos.

### BACKGROUND OF THE INVENTION

Most prior art systems for detecting highlights in videos use a single signaling modality, e.g., either an audio signal or a visual signal. Rui et al. detect highlights in videos of baseball games based on an announcer's excited speech and ball-bat impact sounds. They use directional template matching only on the audio signal, see Rui et al., “Automatically extracting highlights for TV baseball programs,” Eighth ACM International Conference on Multimedia, pp. 105-115, 2000.

Kawashima et al. extract bat-swing features in video frames, see Kawashima et al., “Indexing of baseball telecast for content-based video retrieval,” 1998 International Conference on Image Processing, pp. 871-874, 1998.

Xie et al. and Xu et al. segment soccer videos into play and break segments using dominant color and motion information extracted only from video frames, see Xie et al., “Structure analysis of soccer video with hidden Markov models,” Proc. International Conference on Acoustic, Speech and Signal Processing, ICASSP-2002, May 2002, and Xu et al., “Algorithms and system for segmentation and structure analysis in soccer video,” Proceedings of IEEE Conference on Multimedia and Expo, pp. 928-931, 2001.

Gong et al. provide a parsing system for videos of soccer games. The parsing is based on visual features such as the line pattern on the playing field, and the movement of the ball and players, see Gong et al., “Automatic parsing of TV soccer programs,” IEEE International Conference on Multimedia Computing and Systems, pp. 167-174, 1995.

One method analyzes a soccer video based on shot detection and classification. Again, interesting shot selection is based only on visual information, see Ekin et al., “Automatic soccer video analysis and summarization,” Symp. Electronic Imaging: Science and Technology: Storage and Retrieval for Image and Video Databases IV, January 2003.

Some prior art systems for detecting highlights in videos use combined signaling modalities, e.g., both an audio signal and a visual signal, see U.S. patent application Ser. No. 10/729,164, “Audio-visual Highlights Detection Using Hidden Markov Models,” filed by Divakaran et al. on Dec. 5, 2003, incorporated herein by reference. Divakaran et al. describe generating audio labels using audio classification based on Gaussian mixture models (GMMs), and generating visual labels by quantizing average motion vector magnitudes. Highlights are modeled using discrete-observation coupled hidden Markov models (CHMMs) trained with labeled videos.

Xiong et al., in “Audio Events Detection Based Highlights Extraction from Baseball, Golf and Soccer Games in a Unified Framework,” ICASSP 2003, described a unified audio classification framework for extracting sports highlights from different sport videos including soccer, golf and baseball games. The audio classes in the proposed framework, e.g., applause, cheering, music, speech and speech with music, were chosen to characterize different kinds of sounds that were common to all of the sports. For instance, the first two classes were chosen to capture the audience reaction to interesting events in a variety of sports.

Generally, the audio classes used for sports highlights detection in the prior art include applause and a mixture of excited speech, applause and cheering.

A large volume of training data from the classes is required for training to produce accurate classifiers. Furthermore, because training data are acquired from actual broadcast sports content, the training data are often significantly corrupted by ambient audio noise. Thus, some of the training results in modeling the ambient noise rather than the class of audio event that indicates an interesting event.

Therefore, there is a need for a method to detect highlights from sports videos audio that overcomes the problems of the prior art.

### SUMMARY OF THE INVENTION

The invention provides a method that eliminates corrupting training data to yield accurate audio classifiers for extracting sports highlights from videos.

Specifically, the method iteratively refines a training data set for a set of audio classifiers. In addition, the set of classifiers can be updated dynamically during the training.

A first set of classifiers is trained using audio frames of a labeled training data set. Labels of the training data set correspond to a set of audio features. Each audio frame of the training data set is then classified using the first set of classifiers to produce a refined training data set.

In addition, the set-of classifiers can be updated dynamically during the training. That is, classifiers that do not work well can be discarded and new classifiers can be introduced into-the set of classifiers. The refined training data set can then be used to train the updated second set of audio classifiers.

The training, iterative classifying, and dynamic updating steps can be repeated until a desired final set of classifiers is obtained. The final set of classifiers can then be used to extract highlights from videos of unlabeled content.

### BRIEF DESCRIPTION OF THE DRAWINGS

FIG. 1 is a block diagram of a method for refining a training data set for a set of dynamically updated audio classifiers according to the invention.

### DETAILED DESCRIPTION OF THE PREFERRED EMBODIMENT

The invention provides a preprocessing step for extracting highlights from multimedia content. The multimedia content can be a video including visual and audio data, or audio data alone.

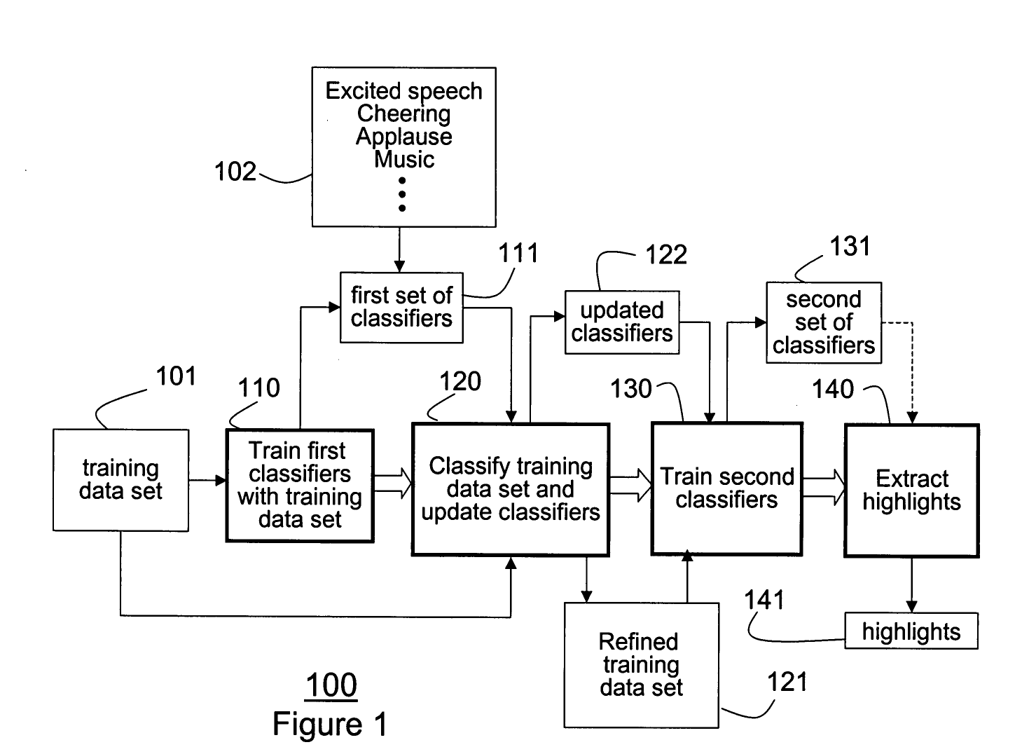

As shown in FIG. 1, the method 100 of the invention takes as input labeled frames of an audio training data set 101 for a set of audio classifiers used for audio highlights detection. In the preferred embodiment, the invention can be used with methods to extract highlights from sports videos as described in U.S. patent application Ser. No. 10/729,164, “Audio-visual highlights detection using coupled hidden Markov models,” filed by Divakaran et al. on Dec. 5, 2003 and incorporated herein by reference. Here, frames in the audio classes include audio features such as excited speech and cheering, cheering, applause, speech, music, and the like. The audio classifiers can be selected using the method described by Xiong et al. in “Audio Events Detection Based Highlights Extraction from Baseball, Golf and Soccer Games in a Unified Framework,” ICASSP 2003, incorporated herein by reference.

The labeled training data set 101 is used to train 110 a first set of classifiers 111 based on labeled audio features 102, e.g., cheering, applause, speech, or music, represented in the training data set 101. In the preferred embodiment, the first set of classifiers 111 uses model that includes a mixture of Gaussian distribution functions. Other classifiers can use similar models.

Each audio frame of the training data set 101 is classified 120 using the first set of classifiers 111 to produce a refined training data set 121. The classifying 120 can be performed in a number of ways. One way applies a likelihood-based classification, where each frame of the training data set is assigned a likelihood or probability of being included in the class. The likelihoods can be normalized to a range [0.0, 1.0].

Only frames having likelihood greater than a predetermined threshold are retained in the refined training data set 121. All other frames are discarded. It should be understood that the thresholding can be reversed. That is, frames having a likelihood less than a predetermined threshold are retained. Only the frames that are retained form the refined training data set 121.

The first set of classifiers 111 is trained 110 for multiple audio features 102, e.g., excited speech, cheering, applause, and music. It should be understood that additional features can be used. The training data set 101 for applause is classified 120 using the first classifiers 111 for each of the audio features. Each frame is labeled as belonging to a particular audio features. Only frames that are classified 120 with labels corresponding to the classified features are retained in the refined training data set 121. Frames that are inconsistent with the audio features are discarded.

In addition, the first set of classifiers can be updated dynamically during the training. That is, classifiers that do not work well can be removed from the set, and other new classifiers can be introduced into the set to produce an updated second set of classifiers 122. For example, if a classifier for music features works well, then variations of the music classifier can be introduced, such as band music, rhythmic organ chords, or bugle calls. Thus, the classifiers are dynamically adapted to the training data.

The refined training data set 121 is then used to train 130 the updated second set of classifiers 131. The second set of classifiers provides improved highlight 141 extraction 140 when compared to prior art static classifiers trained using only the unrefined training data set 101.

In optional steps, not shown in the figures, the second classifier 131 can be used to classify 140 the refined data set 121, to produce a further refined data set. Similarly, the second set of classifier can be updated, and so on. This process can be repeated a predetermined number of iterations, or until the classifiers achieve a user defined level of performance for the extraction 140 of the highlights 141.

This invention is described using specific terms and examples. It is to be understood that various other adaptations and modifications may be made within the spirit and scope of the invention. Therefore, it is the object of the appended claims to cover all such variations and modifications as come within the true spirit and scope of the invention.

We claim:

1. A method for refining a training data set for audio classifiers used to classify multimedia content, comprising:
training a first set of audio classifiers using labeled audio frames of a training data set, in which labels of the training data set correspond to a set of audio features; and
classifying each audio frame of the labeled training data set using the first set of audio classifiers to produce a refined training data set.

2. The method of claim 1, further comprising:
training a second set of audio classifier using audio frames of the refined training data set.

3. The method of claim 2, further comprising:
extracting highlights from unlabeled audio frames using the second set of audio classifiers.

4. The method of claim 1, in which the classifying further comprises:
assigning a likelihood to each audio frame in the labeled training data set according to the first set of audio classifiers; and
retaining each audio frame having a likelihood greater than a predetermined threshold in the refined training data set.

5. The method of claim 1, in which the classifying further comprises:
assigning a likelihood to each audio frame in the labeled training data set according to the first set of classifiers; and
retaining each audio frame having a likelihood less than a predetermined threshold in the refined training data set.

6. The method of claim 4, further comprising:
discarding each audio frame having a likelihood less than the predetermined threshold.

7. The method of claim 5, further comprising:
discarding each audio frame having a likelihood greater than the predetermined threshold.

8. The method of claim 1, in which the first set of audio classifiers is trained for each of a plurality of labeled audio training data sets, the frames of each labeled audio training data set having labels corresponding to a different audio feature, and the classifying further comprising:
classifying each frame of a particular audio training data set for a particular audio feature using the first sets of classifiers to label the frame according to a corresponding one of the different audio features; and
retaining audio frames having a labels corresponding to the particular audio feature in the refined training data set.

9. The method of claim 8, further comprising:
discarding audio frames having labels corresponding to an audio features other than the particular audio feature.

10. The method of claim 1, further comprising:
updating the first set of classifiers to obtain a second set of classifiers.

11. The method of claim 10, in which the updating further comprises:
adding new classifiers to the first set of classifiers to obtain the second set of classifiers; and
removing selected classifiers from the first set of classifiers to obtain the second set of classifiers.

12. A method for classifying data, comprising:
training a set of first classifiers using a training data set;
classifying the training data set using the first set of classifiers to produce a refined training data set;
training a second set of classifiers using the refined training data set; and
classifying the unlabeled data using the second set of classifiers.

13. The method of claim 12, further comprising:
repeating the training and classifying steps until the classifying of the unlabeled data achieves a desired level of performance.
